(19) United States
(12) Patent Application Publication
(10) Pub. No.: US 2026/0088379 A1
(43) Pub. Date: Mar. 26, 2026

(54) Energy Storage Unit for an Electrical Consumer

(71) Applicant: Robert Bosch GmbH, Stuttgart (DE)

(72) Inventors: Benjamin Grauer, Stuttgart (DE); Christoph Klee, Stuttgart (DE); Marc-Alexandre Seibert, Stuttgart (DE); Tina Ringshandl, Leinfelden-Echterdingen (DE); Andrej Stepanov, Holzgerlingen (DE); Tim Brecht, Karlsbad (DE)

(21) Appl. No.: 19/110,895

(22) PCT Filed: Sep. 15, 2023
(86) PCT No.: PCT/EP2023/075428

§ 371 Date: Mar. 12, 2025

(30) Foreign Application Priority Data
Sep. 16, 2022 (DE) 10 2022 209 760.2

(51) Int. Cl. H01M 10/48; H01M 10/653; H01M 50/284

(52) U.S. Cl. CPC H01M 10/486; H01M 10/653; H01M 50/284; H01M 2220/30

(57) ABSTRACT

An energy storage unit for an electrical consumer includes at least one first energy storage cell, at least one first temperature sensor for detecting a temperature of the at least one first energy storage cell, and a circuit board for receiving the at least one first temperature sensor. The at least one first temperature sensor and the circuit board are surrounded, in particular entirely, by a thermally conductive potting compound, which is designed in such a way that it comes into thermal contact with the at least one first energy storage cell, in particular at the location of the at least one first temperature sensor.

The invention relates to an energy storage unit for an electrical consumer according to the preamble of the independent claim 1. The energy storage unit comprises at least one first energy storage cell, at least one first temperature sensor for detecting a temperature of the at least one first energy storage cell and a circuit board for receiving the at least one first temperature sensor.

### PRIOR ART

A large number of electrical consumers are operated using permanently integrated energy storage units (also referred to as rechargeable batteries or battery packs) or removable energy storage units requiring no tool by the user (hereinafter referred to as removable battery packs), which are accordingly discharged by the electrical consumer and can be recharged using a charging device. Typically, such energy storage units consist of a plurality of energy store cells interconnected in series and/or parallel in order to achieve a required battery voltage or capacity. A particularly advantageous and high power and energy density can be achieved if the energy store cells are designed as, e.g., lithium ion cells (Li-ion). On the other hand, in order to prevent electrical fault states, such cells also require adherence to tight specifications regarding the maximum charging and discharging current, voltage and temperature. For example, if the detected temperature is outside of predetermined limits, the discharging or charging operation of the energy storage unit is interrupted or at least restricted.

In modern, battery-powered electrical consumers, the cell voltage of the parallel-connected energy storage cells of a so-called cell cluster of the energy storage unit is evaluated, for example by a monitoring unit. Accordingly, the term “cell voltage” is not only intended to mean the voltage of a single energy storage cell, but also that of a cell cluster consisting of parallel-connected energy storage cells. Such a so-called single cell monitoring (SCM) is known from WO 20043386 A1, for example, in which a hazardous operation of a removable battery pack in the event of a fault is also ruled out by redundant monitoring.

It is the object of the invention to achieve particularly robust and reliable temperature detection in an energy storage unit for safe operation in conjunction with as simple a production of the energy storage unit as possible.

### ADVANTAGES OF THE INVENTION

To solve the above task, it is provided that the at least one first temperature sensor and the circuit board are surrounded, in particular entirely, by a thermally conductive potting compound, wherein the potting compound is designed in such a way that it comes into thermal contact with the at least one first energy storage cell, in particular at the location of the at least one first temperature sensor. With particular advantage, a simple and inexpensive production of the energy storage unit can be made in conjunction with reliable and secure temperature monitoring.

The invention further relates to an electrical consumer comprising an energy storage unit according to the invention, and to a system consisting of an electrical consumer designed as a hand-held power tool and at least one electrical energy storage unit designed as a removable battery pack. However, all devices that can be powered by an energy storage unit, e.g. a removable battery pack or a permanently integrated battery pack, and comprising an electrical load are basically understood as an electrical consumer in the context of the invention. The electrical load can be designed as a predominantly inductive load in the form of an electromotive drive. Likewise, predominantly ohmic or capacitive loads are conceivable. Electrically commutated electric motors (so-called EC or BLDC motors), the individual phases of which are controlled via at least one power transistor by pulse width modulation in order to control and/or regulate their speed and/or torque, are in particular suitable as electromotive drives. In this context, the invention can be applied to battery-powered machine tools for machining workpieces using an electrically driven insertion tool. The electrical machining device can be designed not only as a hand-held power tool, but also as a stationary machine tool. Typical machine tools in this context include hand-held or stationary drills, screwdrivers, impact drills, planers, angular grinders, oscillating sanders, cell polishing machines, or the like. However, suitable electrical consumers also include garden tools and construction equipment, e.g. lawn mowers, lawn trimmers, branch saws, tilling and trenching machines, blowers, robotic breakers and excavators, etc., as well as measuring devices, e.g. laser rangefinders, wall scanners, etc. The invention is also applicable to household appliances, e.g. vacuum cleaners, mixers, etc., and to electrically powered road and rail vehicles, e.g. e-bikes, e-scooters, pedelecs, electric and hybrid vehicles, etc., as well as to airplanes and ships comprising an energy storage unit according to the invention.

The voltage class of the energy storage unit results from the interconnection (parallel or series) of the individual energy storage cells integrated in the energy storage unit and is usually an integer multiple (>=1) of the voltage of the individual energy storage cells. An energy storage cell is typically designed as a galvanic cell which has a structure in which one cell pole comes to lie at one end and a further cell pole comes to lie at an opposite end. In particular, the energy storage cell has a positive cell pole on one end and a negative cell pole on the opposite end. Preferably, the energy storage cells are designed as lithium-based battery cells, e.g., Li-ion, Li-cell polymer, Li-metal, or the like. However, the invention can also be applied to energy storage cells having Ni—Cd cells, Ni—Mh cells, or other suitable cell types. For common Li-ion energy storage cells with a cell voltage of 3.6 V, voltage classes of 3.6 V, 7.2 V, 10.8 V, 14.4 V, 18 V, 36 V, etc. can be used as examples. An energy storage cell is preferably designed as an at least essentially cylindrical round cell, wherein the cell poles are arranged at the ends of the cylindrical shape. However, the invention is not dependent on the type and design of the energy storage cells used, but can be applied to any energy storage units and energy storage cells, e.g., prismatic cells, pouch cells or the like in addition to round cells. The D.C. voltages are primarily based on the typical cell voltages of the energy storage cells being used. For pouch cells and/or cells with a different electrochemical composition, for example, voltage values are possible that differ from those of energy storage units equipped with Li-ion cells.

If the energy storage unit is designed as a removable battery pack, it can be releasably connected in a frictional or interlocking manner via an electromechanical interface of the removable battery pack to a correspondingly complementary electromechanical interface of the electrical consumer or the charging device. The term “releasable connection” is understood in particular to mean a connection that can be released and established without a tool, i.e., manually. The design of the electromechanical interfaces and their receptacles for the frictional and/or interlocking releasable connection are not intended to be an object of the present invention. A person skilled in the art will choose a suitable embodiment for the electromechanical interface depending on the power class or voltage class of the electrical consumer and/or a removable battery pack, so that no further details will be given here. The embodiments shown in the drawings are therefore only to be understood as examples. So, interfaces having more electrical contacts than illustrated can in particular also be used.

In a further development of the invention, it is provided that the at least one first temperature sensor is arranged on a circuit board layer of the circuit board and the potting compound has a recess on a side of the circuit board opposite the circuit board layer in the area of the at least one first temperature sensor, in particular for thermal insulation of the circuit board and/or the at least one first temperature sensor from a housing of the energy storage unit or the electrical consumer. In a particularly advantageous manner, the heat capacity in the direct vicinity of the temperature sensor can be reduced in order to avoid or at least reduce temperature influences of further components and/or the housing of the energy storage unit or the electrical consumer on the temperature sensor.

The recess may be designed in such a way that a cavity is formed between the potting compound and the housing, which defines a distance of the potting compound from the housing at least in the area of the at least one first temperature sensor. Thus, any impairment of the temperature measurement by temperature influences acting on the housing can be further reduced or avoided.

In addition a further temperature sensor is arranged on the circuit board, which is spaced apart from the first temperature sensor in such a way that it detects the temperature of a further energy storage cell, wherein the further temperature sensor is surrounded by the potting compound in such a way that it comes into thermal contact with the further energy storage cell, in particular at the location of the further temperature sensor. Thus, multiple energy storage cells can be monitored in the sense of thermal single cell monitoring and, if necessary, deactivated separately via corresponding switching elements on the circuit board if the temperature exceeds or falls below predetermined limit values.

To optimize the thermal conductivity between the temperature sensor and the energy storage cell, the thermal contact areas of the potting compound are adapted to an outer contour of the energy storage cell. If the energy storage cells are designed as cylinder-shaped round cells, for example, an optimized thermal conductivity is therefore provided if the thermal contact surfaces of the thermally conductive potting compound feature a complementary, in particular concave, shape in order to form as large a surface as possible, which transmits the temperature of the energy storage cells to the temperature sensors. In addition, such an interlocking connection enables simplified assembly of the circuit board, since the correspondingly preformed potting compound causes reproducible positioning on the energy storage cells.

An alternative or supplementary option for reducing or avoiding the impairment of the temperature measurement due to temperature influences acting on the housing is possible in that the potting compound has at least one protruding contact point for the housing of the energy storage unit or the electrical consumer on a side facing away from the at least one first energy storage cell in order to form an air gap between the housing and potting compound. The air gap may also be formed by two contact points of the potting compound, wherein the temperature sensors are arranged substantially centrally between the two contact points.

In a further development of the invention, it is provided that the potting compound is designed as an elastic thermoplastic. Such a thermoplastic can be produced, for example, by so-called low-pressure molding. The circuit board, along with its electrical connection points, is inserted into a negative cast form, which is then filled with a hot, viscous polymer. After the polymer has cooled, a robust and partially elastic shell is produced, which ensures very advantageous protection against corrosion caused by moisture, fingerprints, or the like. The elasticity of the thermoplastic can compensate for tolerances between the circuit board or temperature sensor and energy storage cell, which improves thermal conductivity.

In order to keep the design of the energy storage unit as compact as possible, the circuit board surrounded by the potting compound is arranged at two adjacent energy storage cells such that it does not protrude over an envelope formed by the two energy storage cells in a cross section.

As a rule, the electrical cell poles of at least two energy storage cells of the energy storage unit are electrically conductively connected to each other in a series or parallel circuit via at least one cell connector. The electrical connection of the cell connectors to the electrical cell poles is made by means of a material-locking connection, for example by soldering, cold welding or the like. The cell connectors are designed as flat punched plates or tabs, which in turn are electrically connected to a printed circuit board (PCB) of the energy storage unit for monitoring the energy storage cells via electrical connection points of the circuit board. The electrical connection between the connection points of the circuit board and the cell connectors is also made in a material-locking manner by means of electrical cables, ribbon cables, bonding wires, punching grids or the like. Some of them also use flexible circuit boards (FPC).

In an alternative embodiment of the invention, the task can therefore be seen as achieving a particularly robust electrical connection of individual energy storage cells of an energy storage unit to the circuit board in conjunction with the simplest possible manufacture of the energy storage unit.

To solve the problem, it is provided that the circuit board, along with the electrical connection points, is surrounded, in particular entirely, by a potting compound. In this way, on the one hand, the electrical connections between the circuit board and the cell connector can be well protected against contamination and shunts, and on the other hand, complex and fault-prone soldering during assembly of the energy storage unit can be avoided.

In a further development of the invention, it is provided that the potting compound is formed from a low-pressure molding thermoplastic. In low-pressure molding, the circuit board, along with its electrical connection points, is inserted into a negative cast form, which is then filled with a hot, viscous polymer. After the polymer has cooled, a robust and partially elastic shell is produced, which ensures very advantageous protection against corrosion caused by moisture, fingerprints, or the like. Alternatively, it is also conceivable that the potting compound is formed from a silicone mass with corresponding advantages.

In addition, at least one of the cell connectors comprises an electrical tap for single cell monitoring (SCM) of the energy storage cells. Since no additional material-locking connection is necessary for the SCM tap during the assembly of the energy storage unit, it is at least partially protected against contamination and/or corrosion, so that the risk of an undesired discharge of the energy storage unit or individual energy storage cells can be significantly reduced.

Furthermore, it is provided that at least one of the cell connectors has a tolerance compensation for adjustment to a length of the energy storage cells. Since the electrical connection of the cell connectors to the circuit board is already made during assembly and the individual components each have fixed lengths, the tolerance compensation makes it possible to compensate for any length tolerances of the energy storage cells, the circuit board and/or their connection points. In this case, the tolerance compensation of the cell connector can be designed as a U-shaped, a zigzag or wave-shaped fold parallel to a longitudinal axis of the respective energy storage cell.

The invention also relates to a method for producing an energy storage unit for an electrical consumer, having a plurality of energy storage cells, wherein each energy storage cell has two electrical cell poles and the electrical cell poles of at least two energy storage cells are electrically conductively connected to each other in a series or parallel circuit via at least one cell connector, and having a circuit board which has at least one electrical connection point for the electrically conductive connection of the at least one cell connector. With the advantages mentioned above, the at least one cell connector is first electrically connected, in particular in a material-locking manner, to the electrical connection point in a method step. In subsequent method steps, the circuit board, along with the at least one electrical connection point, is then cast, in particular entirely, with a potting compound and arranged parallel to a longitudinal axis of the energy storage cells in order to connect the at least one cell connector to the electrical cell poles of at least two energy storage cells in a material-locking manner. In the context of the invention, a material-locking connection is to be understood in particular to mean an electrical connection that was produced by soldering, cold welding, or the like.

In a method step of the method according to the invention, it is additionally provided that the circuit board is electrically connected to at least one further circuit board prior to casting with the potting compound by means of a flexible cable, in particular a multi-core ribbon cable. For example, the further circuit board may comprise a plurality of electrical contacts of the electromechanical interface of the energy storage unit designed as a removable battery pack for contacting the electrical consumer or a charger. After casting with the potting compound, the circuit board and the at least one further circuit board are then arranged substantially perpendicular to each other around the energy storage cells in a method step. Instead of a flexible cable, the further circuit board can also be designed as a flexible circuit board and electrically connected directly to the circuit board, in particular in a material-locking manner.

In a further, alternative embodiment of the invention, the task can be seen as achieving particularly simple and accurate temperature detection of an energy storage unit, in particular an energy storage cell of the energy storage unit, for safe operation of the energy storage unit.

To solve the problem, it is provided that the at least one first temperature sensor for thermal coupling to the at least one energy storage cell is arranged on the side edge or on the circuit board layer directly adjacent the side edge. Since the accuracy of the temperature detection is dependent on the thermal conductivity between the energy storage cell and the temperature sensor, the invention makes it possible in a particularly advantageous manner to selectively transfer the heat generated during the charging or discharging process from the energy storage cell to the temperature sensor with as little loss as possible. At the same time, the proposed solution is very cost-effective, especially since no separate assembly devices or adhesive connections are necessary.

In a further configuration, it is provided that the circuit board spans a circuit board plane, wherein a longitudinal axis of the at least one energy storage cell, in particular a plurality of energy storage cells arranged in parallel, is aligned perpendicular to the circuit board plane. In addition, the side edge may be adapted to an outer contour of the at least one energy storage cell at least in the area of the at least one temperature sensor. In addition or alternatively, the side edge comprises at least one contact point with the at least one energy storage cell. In this way, an optimal thermal contact of the temperature sensor positioned at the side edge can be achieved as a function of the outer contour of the at least one energy storage cell.

Furthermore, the thermal contact between the at least one temperature sensor and the at least one energy storage cell may be improved by the circuit board having at least one recess in the vicinity of the at least one first temperature sensor, which causes a spring force of the side edge opposite the at least one energy storage cell in such a way that the at least one energy storage cell deforms the side edge and/or the recess in the assembled state of the circuit board by a compressive force. In the event of a deformation of the side edge, it is preferably compressed in the circuit board plane. Due to the compressive force and the spring force acting in opposition to this, the at least one temperature sensor is always optimally held on the energy storage cell. Furthermore, the recess may cause thermal decoupling of the at least one temperature sensor from the remaining circuit board.

With particular advantage, the at least one first temperature sensor is designed as an SMD component arranged on the at least one circuit board layer or directly in a recess of the side edge. SMD components are designed to be very compact and therefore allow for particularly space-saving and cost-effective assembly in series production.

The thermal coupling may further be improved by the side edge having a thermally conductive coating at least in the direct vicinity of the at least one first temperature sensor.

A supplementary embodiment of the invention provides that a further temperature sensor is arranged on the side edge or a further side edge of the circuit board, wherein the further temperature sensor is spaced apart from the first temperature sensor such that it detects the temperature of a further energy storage cell, in particular largely independent of the first energy storage cell. Thus, multiple energy storage cells can be monitored in the sense of thermal single cell monitoring and, if necessary, deactivated separately via corresponding switching elements on the circuit board if the temperature exceeds or falls below predetermined limit values.

In order to reduce or avoid falsification of the temperature detection, it may also be provided that the circuit board has at least one further recess for thermal decoupling in the vicinity of the at least one first temperature sensor and/or the further temperature sensor.

### EXEMPLARY EMBODIMENTS

### DRAWINGS

The invention is explained below with reference to FIGS. 1 through 13 by way of example, wherein identical reference numbers in the drawings indicate identical components having an identical function.

Shown are:

FIG. 1: an electrical consumer designed as a hammer drill in the prior art in a perspective view,

FIG. 2: an electrical consumer designed as a multi-tool according to the prior art in a perspective view,

FIG. 3: an energy storage unit designed as a 12 V removable battery pack according to the prior art in a perspective view,

FIG. 4: an energy storage unit designed as a 18 V removable battery pack according to the prior art in a perspective view,

FIG. 5: a first exemplary embodiment of an internal part of the energy storage unit according to the invention in a perspective view before (FIG. 5a) and after its assembly (FIG. 5b),

FIG. 6: a detailed view of the interior part of the energy storage unit according to the invention according to FIG. 5,

FIG. 7: a cell connector of the energy storage unit according to the invention according to FIGS. 5 and 6 in a perspective view,

FIG. 8: a section through the energy storage unit according to the invention at about half the length of the energy storage unit,

FIG. 9: a detailed view of the interior part of the energy storage unit according to the invention according to FIGS. 5 to 8 in a perspective view,

FIG. 10: a further embodiment of the energy storage unit according to the invention in a frontal view,

FIG. 11: Detailed views of various alternative embodiments (FIGS. 11a to 11d) of a circuit board of the energy storage unit according to the invention according to FIG. 10,

FIG. 12: a detailed view of a further embodiment of the circuit board of the energy storage unit according to FIG. 10 and

FIG. 13: Detailed views of various alternative embodiments (FIGS. 13a to 13d) of a side edge of the circuit board of the energy storage unit according to the invention according to FIG. 10.

### DESCRIPTION OF THE EXEMPLARY EMBODIMENTS

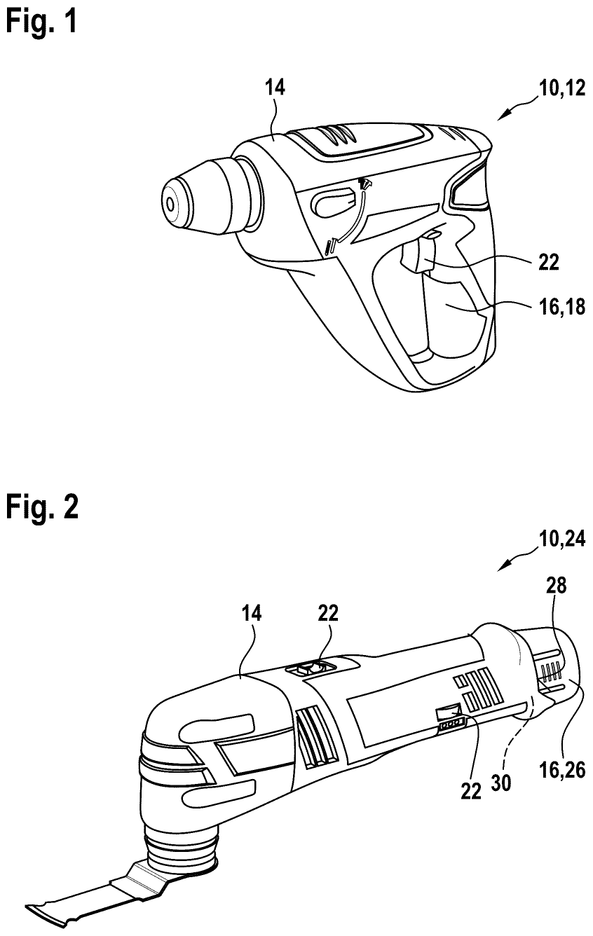

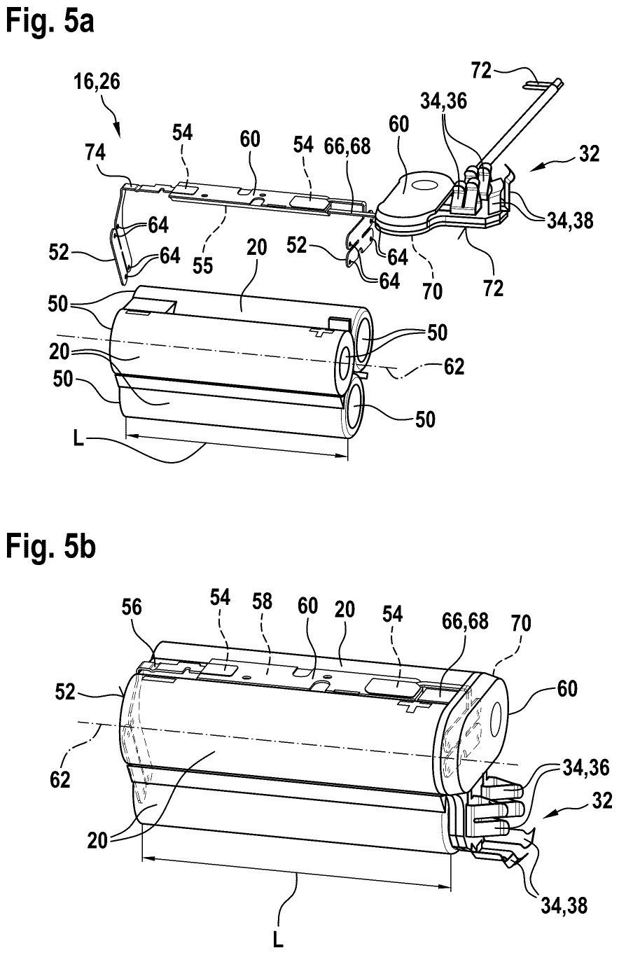

In FIG. 1, an electrical consumer 10 is shown by way of example, which is designed as a hammer drill 12 comprising a housing 14. In addition to a percussion mechanism (not shown in detail), which is driven by an electric motor (also not shown in detail), in particular a brushless DC motor (Electrically Commuted—EC, or Brushless Direct Current—BLDC), an energy storage unit 16 is arranged in the housing 14 of the hammer drill 12 for supplying energy to the electric motor and an electronic system (not shown) which controls said electric motor, whereby the energy storage unit 16 is designed as a permanently integrated battery pack 18 that cannot be replaced by the operator. The battery pack 16 can comprise an individual energy storage cell 20 or a plurality of energy storage cells 20 (see FIGS. 5, 8 and 10). As already mentioned hereinabove, the battery voltage U_{Batt} of the energy storage unit 18 generally results from an integer multiple (>=1) of the individual or cell voltages U_{Cell} of the energy storage cells 20 as a function of their interconnection (parallel or serial). Preferably, the energy storage cells 20 are designed as lithium-based battery cells, e.g., Li-ion, Li—Po, Li-metal, or the like. However, the invention can also be applied to energy storage units 18 having Ni—Cd cells, Ni—Mh cells, or other suitable cell types.

The speed and/or torque of the electric motor designed as an EC motor can, e.g., be controlled or regulated by means of the electronic system and an inverter (e.g., an H-bridge consisting of semiconductor switches, B6-bridge, or the like) controlled by pulse width modulation (PWM) as a function of a main switch 22. Given that the operation of a PWM drive is known to the skilled person, this will not be explained in further detail. In addition, other control or regulating methods for corresponding electric motors are also known without limiting the invention.

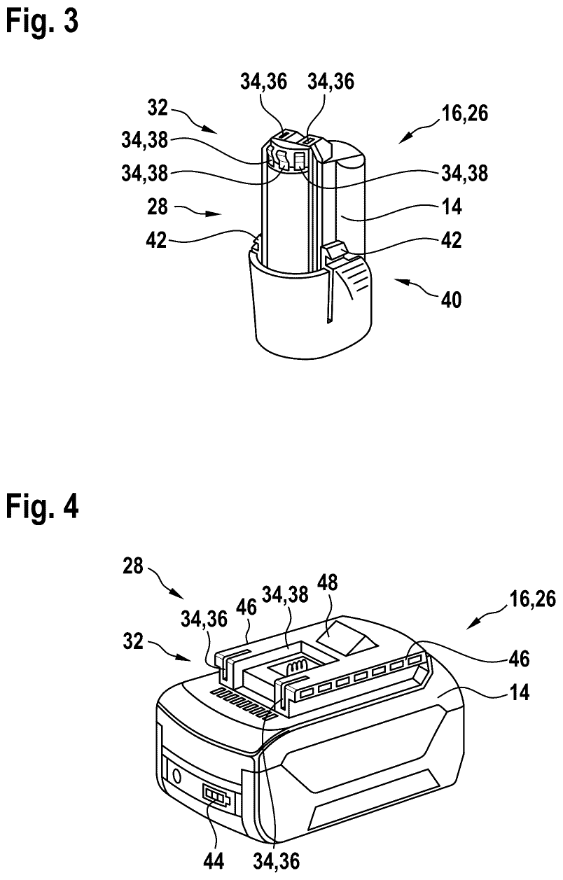

FIG. 2 shows a further exemplary embodiment for an electrical consumer 10 in the form of an electric motor-driven multi-tool 24. Instead of an individual main switch 22, it is divided into a pure on-off switch arranged on the top side of the housing 14 and a speed controller arranged laterally on the housing 14. A further significant difference to the hammer drill 12 shown in FIG. 1 is the interchangeability of the energy storage unit 16 designed as a removable battery pack 26. For a connection to the multi-tool 24 that can be released without tools, i.e. by hand, the removable battery pack 26 comprises an electromechanical interface 28 (see the following embodiments shown in FIGS. 3 and 4), which can be inserted into an electromechanical interface 30 of the multi-tool 24 designed as a plug-in holder. If the removable battery pack 26 is fully inserted, it can supply the required battery voltage U_{Batt} to the multi-tool 26 or its electric motor and electronic system. An inserted removable battery pack 26 is understood in particular to mean as a removable battery pack 26 whose electromechanical interface 28 is connected to the correspondingly complementary electromechanical interface 30 of the electrical consumer 10 in the state connected to the electrical consumer 10.

It should be noted again that the invention can also be applied to electrical consumers featuring purely ohmic and/or capacitive electrical loads, so the electric power tools shown here are understood merely by way of example and are primarily intended to illustrate the different types of energy storage units 20 and their application.

In FIGS. 3 and 4, two different removable battery packs 26 are shown in perspective views. In addition to their characteristic shape, the removable battery packs 26 differ in particular in their battery voltage U_{Batt}, capacity and electromechanical interfaces 28.

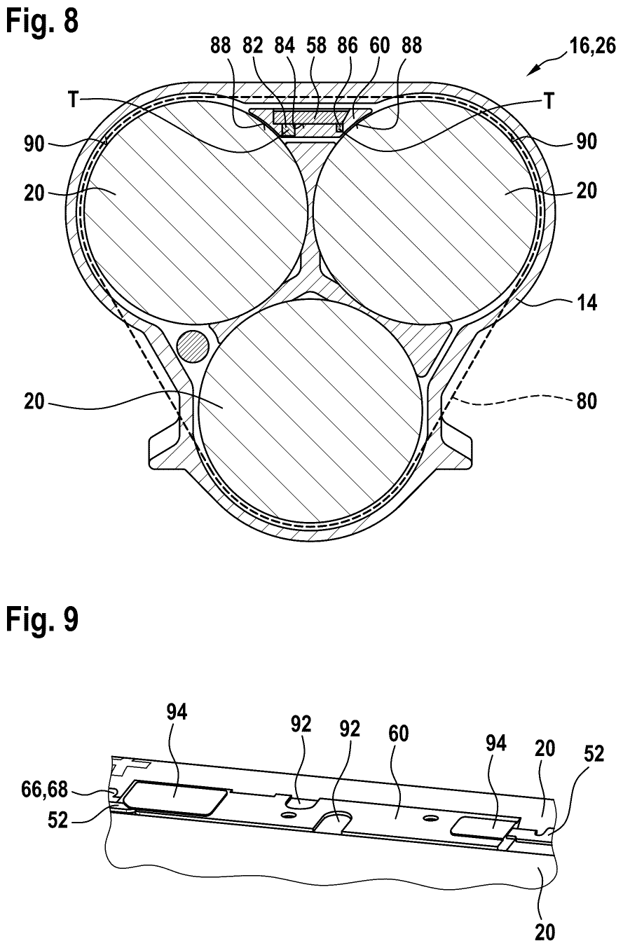

FIG. 3 shows a removable battery pack 26 comprising a battery voltage U_{Batt} of 10.8 V (nominal 12 V). The removable battery pack 26 comprises a housing 14 in which three cylindrical energy storage cells 20 (see FIGS. 5 and 8) are arranged with a respective cell voltage U_{Cell} of 3.6 V and electrically connected in series. The removable battery pack 26 is designed such that it can be inserted into the electrical consumer 10 shown in FIG. 2, which is designed as a multi-tool 24, so that it can be released without tools.

The removable battery pack 26 comprises an electrical contact part 32 of the electromechanical interface 28 at one end, the two electrical contacts 34 designed as power supply contacts 36, and three further electrical contacts 34 designed as signal and data contacts 38. On the one hand, the electrical consumer 10 or the multi-tool 24 can be supplied with power via the power supply contacts 36. On the other hand, it is also possible to charge the removable battery pack 26 by means of a charging device not shown. Via the signal or data contacts 38, information on various operating parameters of the removable battery pack 26, e.g. the battery voltage U_{Batt}, the cell voltages U_{Cell}, a temperature T measured in the removable battery pack 26, a charging or discharging current I, a coding, or the like, can be transmitted to the electrical consumer 10 or the charger for evaluation therein. Based on these operating parameters, the electronic system of the electrical consumer 10 or the charger can control or regulate the discharging or charging process.

A mechanical contact part 40 is arranged on an end of the removable battery pack 26 opposite the end comprising the electrical contact part 32 of the electromechanical interface 28 for the mechanical connection of the removable battery pack 26 to the electrical consumer 10, which can be released without tools. The mechanical contact part 40 comprises two spring-loaded latching lugs 42 that can be connected in a frictional and an interlocking manner to the housing 14 of the electrical consumer 10. Generally, no corresponding latching is necessary in the charging device, so the latching lugs 42 are not used in that location. It is conceivable, however, that the removable battery pack 26 is latched into the charging device during the charging process.

In FIG. 4, a removable battery pack 26 comprising a battery voltage U_{Batt} of 18 V is shown. Ten cylindrical energy storage cells 20 are arranged in two layers in the housing 14 of the removable battery pack 26. Two energy storage cells 20 each are connected in parallel to one cell cluster. The five cell clusters in total are then connected in series such that, at a cell voltage U_{Cell} of 3.6 V each, the resulting battery voltage U_{Batt} is 18 V. A charge state indicator 44 is arranged on the outer surface of the housing 14 of the removable battery pack 26, via which the charge state can be displayed. The electromechanical interface 28 of the rechargeable battery pack 26 has two guide rails 46, which are guided when inserted into the corresponding guide grooves of the electromechanical interface 30 of the electrical consumer 10 or of the charger. A locking element 48 is also provided, which is designed to lock the removable battery pack 26 on the electrical consumer 10. The locking element 48 is designed as a pivotable and elastically mounted latching that engages automatically at the end of the insertion process. The inserted rechargeable battery pack 26 can be unlocked by actuating a mechanical actuating element (not shown), which is arranged on a side of the rechargeable battery pack 26 opposite the charge status indicator 44. The electrical contact part 32 of the electromechanical interface 28 is arranged between the two guide rails 46 and comprises a plurality of electrical contacts 34 for energy and data transmission according to the removable battery pack 26 shown in FIG. 3. In particular, the signal or data contact 38 is designed as a coil, which transmits the operating parameters inductively to the electrical consumer 10. Accordingly, an electrical contact 34 is also understood to mean a contact that enables the contactless transmission of energy and/or data.

FIG. 5a shows the inner part of the removable battery pack 26 shown in FIG. 3 before its assembly. The removable battery pack 26 comprises three Li-Ion energy storage cells 20 arranged in such a way that their cross section features a substantially triangular outer contour (see also FIG. 8). Each energy storage cell 20 in turn comprises a positive and a negative cell pole 50 at its end faces. In FIG. 5b, the removable battery pack 26 is shown after assembly of the inner part. In contrast to FIG. 3, the electrical contact part 32 of the electromechanical interface 28 only comprises two instead of three signal or data contacts 38. The three energy storage cells 20 are connected in series by means of two cell connectors 52 such that, at a cell voltage U_{Cell} of 3.6 V each, the resulting battery voltage U_{Batt} is 10.8 V.

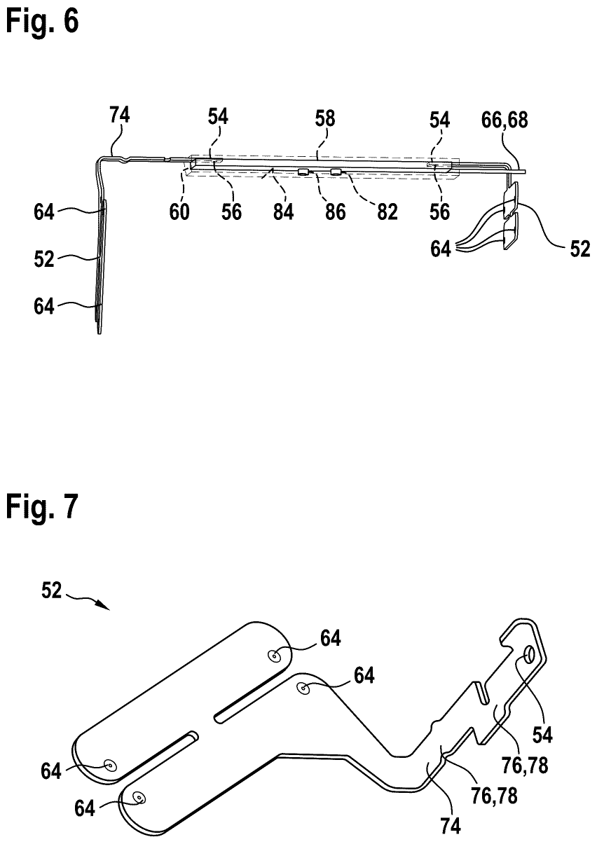

Each cell connector 52 is designed as a flat punched plate which, on the one hand as shown in FIG. 6, is electrically connected at a first end 54 to an electrical connection point 56 of a first circuit board 58 by means of a bonded connection, e.g. by soldering. Subsequently, the circuit board 58, along with its electrical connection points 56 and the ends 54 of the cell connectors 52, are cast, in particular entirely, with a potting compound 60. The potting compound 60 can, e.g., be formed from a low-pressure molding thermoplastic. In low-pressure molding, the circuit board 58, along with its electrical connection points 56, is inserted into a negative cast form, which is then filled with a hot, viscous polymer. After the polymer has cooled, a robust and partially elastic shell is produced, which ensures very advantageous protection against corrosion caused by moisture, fingerprints, or the like. Alternatively, it is also conceivable that the potting compound 60 is formed from a silicone mass. FIG. 6 shows the circuit board 58, along with its electrical connection points 56, and the ends 54 of the cell connectors 52 after casting with the potting compound 60 in a lateral cutaway representation, wherein the potting compound 60 is shown in dashed lines for better illustration of the interior.

In a subsequent step, the cast circuit board 58 is arranged parallel to a longitudinal axis 62 of the energy storage cells 20 with reference to FIGS. 5a and 5b. Finally, the cell connectors 52, which are designed as flat punched plates or tabs, corresponding to FIG. 5b, are connected to the cell poles 50 of the energy storage cells 20 in a material-locking manner by a cold-weld process via corresponding contact points 64 (see also FIG. 7) at the end of the assembly of the inner part.

The circuit board 58 may be electrically connected to at least one further circuit board 70 prior to casting with the potting compound 60 by means of a flexible conduit 66, in particular a multi-core ribbon cable 68. In particular, the further circuit board 70 is connected to two further punched plates 72, which serve to electrically connect the positive cell pole 50 of the first energy storage cell 20 and the negative cell pole 50 of the last energy storage cell 20 of the series circuit with the positive or negative power supply contact 36 of the electromechanical interface 28. The two power supply contacts 36 are soldered directly on the further circuit board 70, but can also be electrically connected with corresponding cables. The same applies to the further stamping plates 72. The circuit board 58 and the at least one further circuit board 70 are finally arranged substantially perpendicular to each other around the energy storage cells 20 after the respective casting with the potting compound 60.

At least one of the cell connectors 52 comprises an SCM tap 74 for single cell monitoring, which is integrally connected to the cell connector 52 and is preferably arranged between the end 54 for electrical contact with the circuit board 58 and the contact points 64 for electrical contacting the cell poles 50 of the energy storage cells 20. The SCM tap 74 is connected in a bonded manner, e.g. by soldering, to a cable (not shown), which in turn is connected to an SCM pre-stage (not shown) of a corresponding electronic system, which is arranged either in the removable battery pack 26 or in the electrical consumer 10, if it comprises a permanently integrated battery pack 18, as shown in FIG. 1. To detect the individual cell voltages U_{Cell}, the SCM pre-stage switches sequentially between the individual SCM taps 74 of the cell connectors 52, e.g. via integrated transistors, such that it is connected to a positive and a negative cell pole 50 of the energy storage cell 20. In this case, the term “energy storage cell” is also intended to include a cell cluster since the former only influences the capacitance of the rechargeable battery pack 10, but is equivalent with regard to the detection of the cell voltages U_{Cell}.

The electronic system of the removable battery pack 26 or the electrical consumer 10 can have an integrated circuit in the form of a microprocessor, ASICs, DSPs, or the like to control or regulate the charging or discharging operation. It is also conceivable that the control or regulation occurs by means of several microprocessors or at least in part by means of discrete components comprising corresponding transistor logic. In addition, the electronic system can comprise a memory for storing the operating parameters. Given that this type of electronic system is known to the skilled person, this will not be explained further.

In FIG. 7, one of the cell connectors 52 is shown in a detail view. This comprises at least one tolerance compensation 76 for adjustment to a length L of the energy storage cells 20 (see FIGS. 5a and 5b). The tolerance compensation 76 of the cell connector 52 is designed parallel to the longitudinal axis 62 of the respective energy storage cell 20 as a U-shaped fold 78, wherein the orientation of the fold 78 can be designed differently depending on the space conditions and the material thickness of the punching plate. Instead of a U-shaped fold, a zigzag or wave-shaped fold is also conceivable. Since the electrical connection of the cell connectors 52 to the circuit board 58 is already made during assembly and the individual components each have fixed lengths, the tolerance compensation 76 makes it possible to compensate for any length tolerances of the energy storage cells 20, the circuit board 58 and/or their connection points 54, 56.

FIG. 8 shows a cross section of the removable battery pack 26 through the three energy storage cells 20 arranged in a triangle surrounded by the housing 14 of the removable battery pack 26. The section shown is located approximately at half the length L of the energy storage cells 20 (see FIG. 5). In order to keep the design of the removable battery pack 26 as compact as possible, the circuit board 58 surrounded by the potting compound 60 is arranged at two adjacent energy storage cells 20 in such a way that it does not protrude over an envelope 80 formed by the two energy storage cells 20 in a cross section.

The temperature T of at least one of the energy storage cells 20 can be measured by means of a first temperature sensor 82, which is preferably designed as an NTC and arranged in a surface mounted device (SMD) design on a circuit board layer 84 of the circuit board 58, and evaluated by the electronic system of the removable battery pack 26 or of the electrical consumer 10 or of the charger. To this end, the first temperature sensor 82 is in the closest possible thermal contact with the energy storage cell 20. In addition, it is electrically connected to one of the signal or contacts 38 of the electromechanical interface 28 for transmitting the detected temperature T. In the case of a battery pack 18 permanently integrated into the electrical consumer 10, the first temperature sensor 82 can also be connected directly to the electronic system of the electrical consumer 10. In particular, the circuit board 58 and the first temperature sensor 82 are surrounded, in particular entirely, by the potting compound 60. For a particularly good thermal connection of the temperature sensor 82 to the energy storage cell 20, the potting compound 60 is designed to be thermally conductive and comes into thermal contact with the energy storage cell 20, in particular at the location of the temperature sensor 82.

In addition to the first temperature sensor 82, a further temperature sensor 86 is arranged on the circuit board 58, which is spaced apart from the first temperature sensor 82, such that it detects the temperature T of a further energy storage cell 20. The further temperature sensor 86 is surrounded by the thermally conductive potting compound 60 in the same way as the first temperature sensor 82 in such a way that it makes the best possible thermal contact with the further energy storage cell 20, in particular at the location of the further temperature sensor 86. Thus, both energy storage cells 30 can be monitored in terms of thermal single cell monitoring and, if necessary, dropping below predetermined temperature limits separately via corresponding switching elements on the circuit board 58, for example by the SCM precursor.

To optimize the thermal conductivity between the temperature sensors 82, 86 and the energy storage cell 20, the thermal contact areas 88 of the thermally conductive potting compound 60 is adapted to an outer contour 90 of the energy storage cell 20. In the present exemplary embodiment, the energy storage cells 20 are designed as cylindrical round cells. An optimized thermal conductivity is therefore provided if the thermal contact surfaces 88 of the thermally conductive potting compound 60 feature a complementary, concave shape in order to form as large a surface as possible, which transmits the temperature T of the energy storage cells 20 to the temperature sensors 82, 86. In addition, such an interlocking connection enables simplified assembly of the cast circuit board 58, since the correspondingly preformed potting compound 60 causes reproducible positioning on the energy storage cells 20. As mentioned hereinabove, other forms of energy storage cells 20 are conceivable as well. Accordingly, the thermal contact surfaces 88 of the thermally conductive potting compound 60 should be designed to complement this.

According to FIG. 9, a recess 92 is provided in the potting compound 60 on a side of the circuit board 58 opposite the circuit board layer 84 in the area of the temperature sensors 82, 86. The recesses 92 serve in particular to achieve thermal insulation of the circuit board 58 or the temperature sensors 82, 86 from the housing 14 of the removable battery pack 26 or the electrical consumer 10. As a result, the heat capacity in the direct vicinity of the temperature sensors 82, 86 can be reduced in order to avoid or at least reduce temperature influences of further components and/or the housing 14 of removable battery pack 26 or the electrical consumer 10 on the temperature sensors 82, 86. The recesses 92 may be designed in such a way that a cavity is formed between the potting compound 60 and the housing 14, which defines a distance of the potting compound 60 from the housing 14 at least in the area of the two temperature sensors 82, 86. Thus, any impairment of the temperature measurement by temperature influences acting on the housing 14 can be further reduced or avoided.

In order to further reduce or avoid any impairment of the temperature measurement due to temperature influences acting on the housing 14, the thermally conductive potting compound 60 also has two protruding contact points 94 for the housing 14 of the removable battery pack 14 or the electrical consumer 10 on the side facing away from the energy storage cells 20 or the temperature sensors 82, 86 in order to form an air gap between the housing 14 and the potting compound 60. Preferably, the two temperature sensors 82, 86 are substantially centrally arranged between the two contact attachment points 94, i.e., approximately half the length L of the energy storage cells 20 (see FIG. 5b).

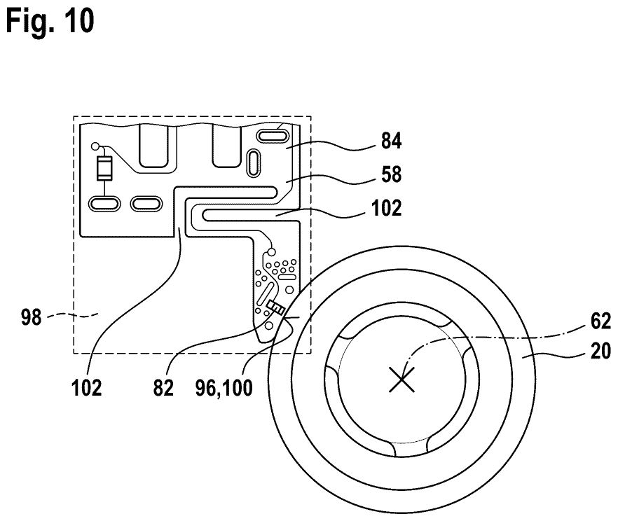

FIGS. 10 to 13 show further exemplary embodiments for thermally coupling the temperature sensors 82, 86 to the energy storage cells 20 in order to achieve a high accuracy of the temperature detection by optimizing thermal conductivity between the energy storage cells 20 and the temperature sensors 82, 86.

In FIG. 10, the temperature sensor 82 for thermal coupling with the energy storage cell 20 is arranged on the circuit board layer 84 directly adjacent a side edge 96 of the circuit board 58. The circuit board 58 spans a circuit board plane 98 that is aligned perpendicular to the longitudinal axis 62 of the energy storage cell 20. Alternatively, it is also contemplated to arrange the temperature sensor 82 directly in a corresponding recess of side edge 96. The thermal coupling may also be improved if the side edge 96 has a thermally conductive coating 100 at least in the direct immediate vicinity of the temperature sensor 82. It is also contemplated with reference to the previous exemplary embodiment according to FIGS. 5 to 9, that the circuit board is enclosed, in particular entirely, in the area of the side edge 96, by the thermally conductive potting compound 60. Thus, the heat generated during the charging or discharging process may be transferred from the energy storage cell 20 to the temperature sensor 82 in a targeted and low-loss manner. At the same time, assembly is cost-effective as no separate mounting devices or adhesive connections are necessary. The temperature sensor 82 is designed as an SMD component which is arranged on the circuit board layer 84 or directly in the recess (not shown) on the side edge 96. This allows a very small design and a good selective temperature measurement in conjunction with simple serial production.

The side edge 96, in the area of the temperature sensor 82, is adapted to the outer contour 90 of the energy storage cell 20. In the present exemplary embodiment, the energy storage cell 20 is designed as a cylindrical round cell. This results in an optimized thermal conductivity when the side edge 96 of the circuit board 58 has a complementary concave shape. As mentioned hereinabove, however, other forms of energy storage cells 20 are conceivable as well. Accordingly, the side edge 96 should then be designed to complement this.

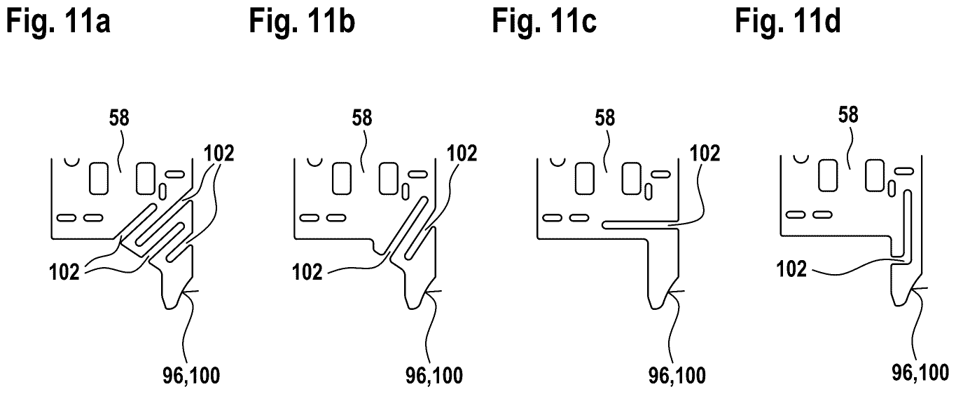

A particularly good thermal contact between the temperature sensor 82 and the energy storage cell 20 can also be achieved by the circuit board 58 having at least one recess 102 in the vicinity of the temperature sensor 82. In the assembled state of the circuit board 58, the energy storage cell 20 deforms the recess 102 by a corresponding compressive force, such that a spring force of the side edge 96 with respect to the energy storage cell 20 is created. It is also contemplated that the side edge 96 also deforms itself by being compressed by the energy storage cell 20 in the circuit board plane 98. In particular, if the recess 102 is surrounded by two areas of the circuit board 58 (not shown). Due to the compressive force and the spring force acting in opposition to this, the temperature sensor 82 is always optimally held on the energy storage cell 20. Furthermore, the recess 102 may cause thermal decoupling of the at least one temperature sensor 82 from the remaining circuit board 58. The effect of the spring force and optionally also the thermal insulation can be further enhanced by the use of a plurality of recesses 102 in the circuit board 58. In FIGS. 11a to 11d, four further variants for a different number, arrangement and/or shape of recesses 102 are shown, by way of example.

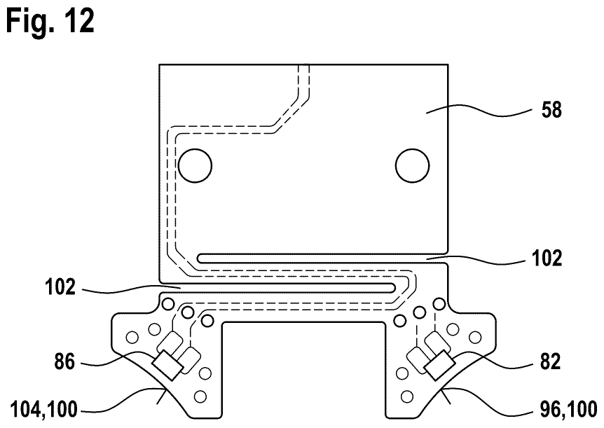

According to FIG. 12, the circuit board 58 may also be designed in such a way that the further temperature sensor 86 is arranged on a further side edge 104 of the circuit board 58 in order to detect the temperature T of a further energy storage cell 20. The further temperature sensor 86 is spaced apart from the first temperature sensor 82 such that it can detect the temperature T of the further energy storage cell 20 largely independent of the first energy storage cell 20. Thus, multiple energy storage cells 20 can be monitored in the sense of thermal single cell monitoring and, if necessary, deactivated separately via corresponding switching elements on the circuit board 58 or by an electronic system of the electrical consumer 10 if the temperature exceeds or falls below predetermined limit values. The thermal coupling may also be improved analogously to the first side edge 96 if the further side edge 104 has the thermally conductive coating 100 at least in the direct immediate vicinity of the temperature sensor 86. A particularly good thermal contact between the temperature sensors 82, 86 and the energy storage cells 20 can also be achieved by the circuit board 58 also having at least one recess 102 in the vicinity of the further temperature sensor 86, which operates according to the recess 102 for the first temperature sensor 82.

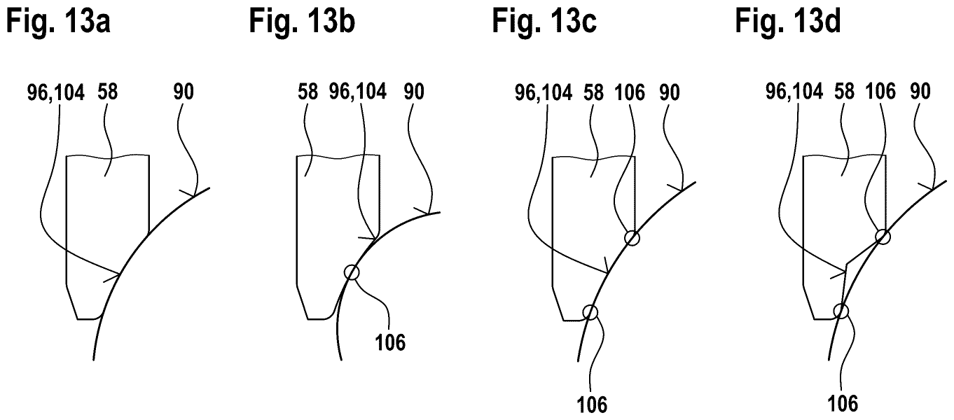

Instead of side edges 96, 104 lying flat on the outer contour 90 of the energy storage cells 20 to be monitored (see FIG. 13a), it is also contemplated with reference to FIGS. 13b and 13c that the side edges 96, 104 have one or two contact points 106 to the respective energy storage cells 20. In this way, optimal thermal contact of the temperature sensors 82, 86 positioned at the side edges 96, 104 can be achieved as a function of the radius of the outer contours 90 of the energy storage cells 20. While a single contact point 106 according to FIG. 13b is particularly advantageous for small radii of the energy storage cells 20, energy storage cells 20 with larger radii according to FIG. 13b can be better thermally connected via two contact points 106. Another option for thermal connection is shown in FIG. 13d, in which the side edge 96 or 104 is V-shaped and thus always has two defined contact points 106 for different radii or outer contours 90 of the energy storage cells 20.

Finally, it should be pointed out that the exemplary embodiments shown is not limited to FIGS. 1 to 13 or to the shape, number and size of the energy storage cells 20 shown therein. Accordingly, the number of temperature sensors can also vary. In addition to NTC, PTC, and other types of temperature sensors can also be used. Likewise, the invention is not limited to circuit boards 58 having only one circuit board layer 84, but can also be applied to what are referred to as multi-layer PCBs.

1. An energy storage unit for an electrical consumer comprising:
at least one first energy storage cell;
at least one first temperature sensor configured to detect a temperature of the at least one first energy storage cell; and
a circuit board configured to receive the at least one first temperature sensor,
wherein the at least one first temperature sensor and the circuit board are surrounded by a thermally conductive potting compound,
wherein the thermally conductive potting compound is designed in such a way that it the thermally conductive potting compound comes into thermal contact with the at least one first energy storage cell.

2. The energy storage unit according to claim 1, wherein the at least one first temperature sensor is arranged on a circuit board layer of the circuit board and the potting compound has a recess on a side of the circuit board opposite the circuit board layer in an area of the at least one first temperature sensor.

3. The energy storage unit of claim 2, wherein the recess is designed in such a way that a cavity is formed between the potting compound and a housing of the energy storage unit that defines a distance of the potting compound to the housing at least in the area of the at least one first temperature sensor.

4. The energy storage unit according to claim 1, further comprising:
a second temperature sensor arranged on the circuit board spaced apart from the first temperature sensor in such a way that the further temperature sensor detects the temperature of a second energy storage cell,
wherein the second temperature sensor is surrounded by the potting compound, in such a way that the second temperature sensor comes into thermal contact with the second energy storage cell a location of the further second temperature sensor.

5. The energy storage unit according to claim 1, wherein thermal contact areas of the potting compound are adapted to an outer contour of the energy storage cells.

6. The energy storage unit according to claim 1, wherein the energy storage cells are designed as cylindrical round cells and thermal contact surfaces of the potting compound are complementary to the cylindrical round cells.

7. The energy storage unit according to claim 1, wherein the potting compound has at least one protruding contact point for a housing of the energy storage unit or the electrical consumer on a side facing away from the at least one first energy storage cell.

8. The energy storage unit according to claim 7, further comprising:
a second temperature sensor arranged on the circuit board spaced apart from the first temperature sensor in such a way that the second temperature sensor detects the temperature of a second energy storage cell,
wherein the second temperature sensor is surrounded by the potting compound, in such a way that the second temperature sensor comes into thermal contact with the second energy storage cell at a location of the second temperature sensor, and
wherein the at least one protruding contact point comprises two contact points, and the first and second temperature sensors are arranged substantially centrally between the two contact points.

9. The energy storage unit according to claim 1, wherein the potting compound is an elastic thermoplastic.

10. The energy storage unit according to claim 1, wherein the circuit board surrounded by the potting compound is arranged on two adjacent energy storage cells of the at least one first energy storage cell in such a way that the circuit board does not protrude over an envelope formed by the two energy storage cells in a cross section.

11. An electrical consumer comprising:
the energy storage unit according to claim 1.

12. A system comprising:
an electrical consumer designed as a hand-held power tool; and
at least one electrical energy store designed as a removable battery pack.

13. The energy storage unit according to claim 1, wherein the at least one first temperature and the circuit board are entirely surrounded by the thermally conductive potting compound.

14. The energy storage unit according to claim 13, wherein the thermally conductive potting compound comes into thermal contact with the at least one first energy storage cell at a location of the at least one first temperature sensor.

15. The energy storage unit according to claim 2, wherein the recess is configured to thermally insulate the circuit board and/or the at least one first temperature sensor from a housing of the energy storage unit or the electrical consumer.
